(19) United States
(12) Patent Application Publication
(10) Pub. No.: US 2004/0098322 A1
(43) Pub. Date: May 20, 2004

(54) Remote monitoring of consumables for a computer to plate imaging system

(75) Inventors: John Kalbfleisch, Vancouver (CA); Douglas Manness, North Vancouver (CA)

Correspondence Address: OYEN, WIGGS, GREEN & MUTALA, 480 - THE STATION, 601 WEST CORDOVA STREET, VANCOUVER, BC, V6B 1G1, CA

(73) Assignee: Creo Inc., Burnaby (CA)

(21) Appl. No.: 10/704,568

(22) Filed: Nov. 12, 2003

Related U.S. Application Data
(60) Provisional application No. 60/426,906, filed on Nov. 18, 2002.

(30) Foreign Application Priority Data
Nov. 12, 2002 (CA) 2411487

(51) Int. Cl. G06F 17/60

(52) U.S. Cl. 705/28

(57) ABSTRACT

In a system for monitoring the usage of consumable items in a computer to plate imaging line, usage data is transferred to a remote management information system (MIS), which may be run by a media vendor or other service company. The remote MIS monitors the consumable inventory for a plant against pre-determined order points. An order is initiated if the inventory falls below the pre-determined order point.

### Reference to Related Application

This application claims the benefit of the filing date of U.S. patent application Ser. No. 60/426,906 filed on Nov. 18, 2002 and claims convention priority from Canadian patent application No. 2,411,487 filed on Nov. 12, 2002.

### TECHNICAL FIELD

The invention relates to the field of managing consumable items for printing plants.

### BACKGROUND

Computer-to-plate (CTP) systems are increasingly used in the preparation of a wide range of plates, films, and other media for printing operations. The ability to make printing plates directly and very quickly permits printing plants to streamline operations while enjoying increased automation and control. A wide variety of plate types and sizes along with various other media such as proofing media or film may be used on a continual basis. The associated media inventory that must be maintained represents a considerable investment. Managing inventory levels so that the correct types and sizes of media are on hand without having an overly large inventory is a challenge for a printing operation.

With increased automation of printing plants, specifically in the pre-press area, integrated systems that manage and automate portions of the printing process are now available (the process of preparing plates for a printing operation is commonly referred to as pre-press). One such product is Synapse® Link sold by Creo Inc. of Burnaby, British Columbia, Canada. Synapse essentially networks computerised Management Information Systems (MIS) and hardware output devices (such as CTP systems) in a printing plant, allowing extensive monitoring, recording and control of many aspects of the printing process including scheduling and inventory management.

### SUMMARY OF EMBODIMENTS OF THE INVENTION

One aspect of this invention provides methods for remotely monitoring consumable usage in printing plants. The methods comprise establishing an order point for at least one consumable item used in a computer-to-plate imaging line at the printing plant and determining an initial inventory level for the consumable item. The inventory level for the consumable item is updated based on the usage of the item. A communication link to a remote management information system is established for transferring consumption information relevant to the consumable item to the remote management information system. An order fulfilment process is initiated when the updated inventory level falls below the order point.

Another aspect of this invention provides a system for monitoring usage of consumable items in printing plants. The system comprises a computer-to-plate imaging line capable of tracking the usage of at least one consumable item and a remote management information system. A transmission channel is operably connected between the imaging line and the remote management information system for transferring information concerning the usage of the consumable item.

Further aspects of the invention and features of various embodiments of the invention are set out below.

### BRIEF DESCRIPTION OF THE DRAWINGS

In drawings which illustrate by way of example only preferred embodiments of the invention:

FIG. 1 is a schematic view of a CTP system; and

FIG. 2 is a process flowchart of a method in accordance with the present invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The present invention is described in relation to a consumable management system wherein consumable usage is monitored directly by pre-press CTP systems and then uploaded or otherwise communicated to a central MIS system located remotely. A central MIS system may be provided by a media vendor and may monitor inventory from many such customers. The term Computer-to-Plate is commonly used to describe imaging systems and associated control hardware that are capable of exposing printing plates directly but may also be capable of imaging other media types, or a combination of different types of media.

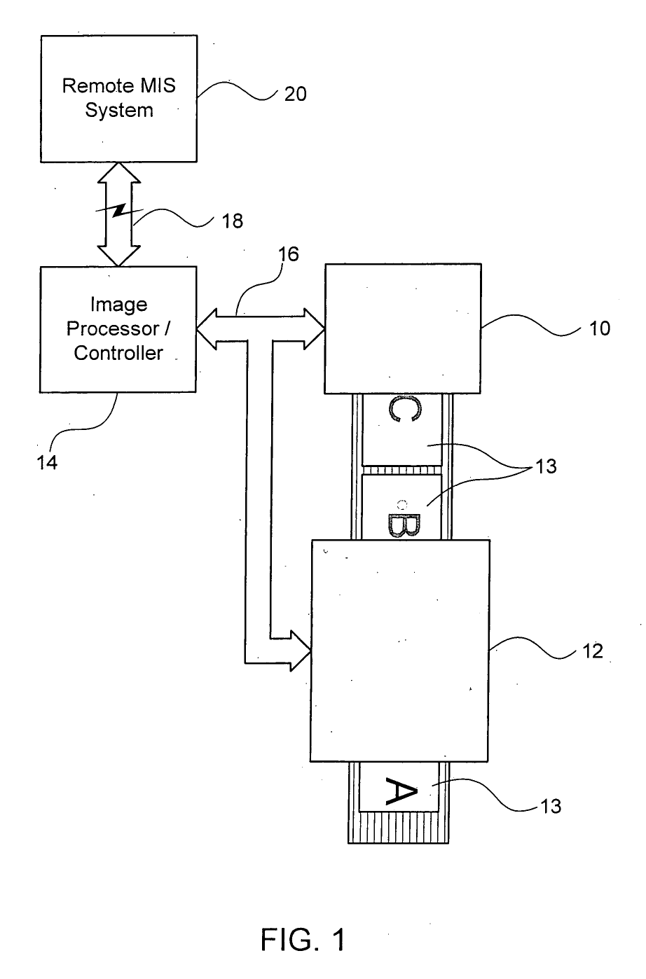

FIG. 1 shows a schematic diagram of a CTP system comprising an imaging unit 10, an optional media processor unit 12 for performing secondary processing of a media 13, and a controller 14. Controller 14 generally performs the functions of receiving image data, optionally converting that image data into a format that may be output to imaging unit 10 and initiating and controlling the imaging operation. Processor 12 may take on many forms and may or may not include pre-bake or post bake ovens, rinsing or gumming units, other apparatus for performing a post-imaging process or the like. In practice, there are a wide variety of different configurations for CTP systems, that shown in FIG. 1 being just one such possibility. The location of controller functions may vary considerably.

Controller 14 is linked to imaging unit 10 by a data link 16. Data link 16 can transfer imaging data, control signals and other information pertinent to the imaging operation. Optionally controller 14 may also be linked to processor unit 12 for transfer of information regarding processing operations as described in commonly assigned U.S. application Ser. No. 10/376,500 which is hereby incorporated herein by reference. In some instances, processor 12 may not be needed at all, as would be the case for a processless media where the media is ready for use directly on completion of imaging.

The consumables used by the CTP system may be of various types and may include media such as lithographic, flexographic or gravure plates or sleeves, films, and/or proofing media, chemicals for processing, filter elements or any other items consumed in imaging or processing operations. Consumption information relevant to the consumption of consumable items of one or more types may be generated in one or more of the imaging unit 10, the controller 14, and the processor 12. The consumption information is transmitted back via link 18 to a remote MIS system 20 for further processing. Examples of consumption information include a number of media of a particular type which have been imaged; an aggregate imaged area; a number of media items remaining in inventory or the like.

The term “Management Information System” or “MIS” is used herein to encompass any of a range of systems adapted for managing business practices such as sales, manufacturing, purchasing or inventory. At a base level, such a system may be a Material Requirements Planning (MRP) system, which is well known in the art. The functionality of the system may also include a reporting function in that a remote MIS may create a report in which inventory, costs or usage or any other data may be communicated to the printing plant by some means such as electronic transfer, fax, email or postal mail.

MIS 20 is remote from the CTP system in the sense that it can operate separately from any particular CTP system. MIS 20 could be located on the same premises as one or more CTP systems although MIS 20 typically serves at least one, and typically several CTP systems which are not located in the same premises as MIS 20.

As an example of an application of the invention, the details of plates of one or more types being used in a CTP system may be monitored in an existing imaging unit 10. This information is often required to set up the imaging unit 10 for a successful imaging operation. Some imaging systems accumulate statistics on the number and types of plates that have passed through the system. The data may be held in local memory to aid in diagnostic or performance monitoring. Such data is used as, or as part of, consumption information in some embodiments of the invention.

The consumption information may be accumulated and then transferred to remote MIS 20 on a periodic or continuous basis.

Link 18 may be provided by any suitable data transfer mechanism. Examples of data transfer mechanisms that may be used to implement link 18 include modems connected to telephone lines, Internet connections, Local Area Network (LAN) connections, email, wireless connections or any other known method of transferring information between computerised systems. One transfer protocol known as Job Definition Format (JDF) has been developed by a consortium of graphic arts companies and is now presented as an open system by CIP4, an international operating standards body in Switzerland. JDF along with Job Messaging Format (JMF) aims to provide non-proprietary formats for transfer of print job data and monitoring of printing operations. Alternately, any one of a number of transfer protocols may be employed and in as much that these protocols are well known in the art they are not further discussed herein. The protocol preferably permits the transmission of an identifier which uniquely identifies a printing plant from which the transmitted consumption information originated.

While consumption such information may also be generated and transferred directly from processor unit 12, processors typically have a simpler construction than imaging devices and may not include logging and communication capabilities. On the other hand processors with more sophisticated controls are becoming available and transfer of consumption information directly from a processor to a remote MIS falls within the scope of the present invention.

Some embodiments of the invention provide a separate counting mechanism that is dedicated to the process of monitoring consumable usage and updating remote MIS 20. A counting mechanism may be provided in the form of a unit comprising a reader that is able to sense the size or type of media passing a particular point, or read a code such as an imprinted barcode or other machine readable tag on the consumable and accumulate the relevant statistics. The unit may further comprise a communication mechanism for transferring the accumulated statistics to remote MIS 20. The use of codes imprinted on the media or the media packaging may also be used to provide additional inventory details such as, for example, media batch numbers or expiry dates.

The usage of any other consumables that are monitored on a periodic or continuous basis may likewise be communicated back to remote MIS 20. For example, a CTP may include filters for cooling air, pressurized air supply, or for collecting debris generated in imaging certain media. These filters may be monitored in any of a number of ways, such as by recording a pressure drop across a filter element and comparing it with a previously determined threshold value. On reaching the threshold level, information may be transferred to the remote MIS to initiate an order for a new filter element.

Some embodiments of the invention trigger orders on actual consumption as reported by the system but this is not mandated. The consumption of a particular item may be predicted based on passage of time or the consumption of one or more related items. An example of this is the chemical solutions that may be used in a processor. While it is technically possible to monitor the usage of solutions directly by a measurement of some parameter such as conductivity, most processors are not equipped to provide such measurements and may not even provide facilities for transferring information. In this case, the consumption of media, as a related item, may be used to predict chemistry consumption. A more complex and possibly more accurate prediction may be made by including in the calculation, for example, an elapsed time component, an estimated rate of comsumption, a measured historical consumption rate; and/or the actual accumulated area of media imaged. This prediction allows the usefulness of the system to be extended past items that can be directly logged or measured to consumables of other types whose state can be determined by observation of another related event.

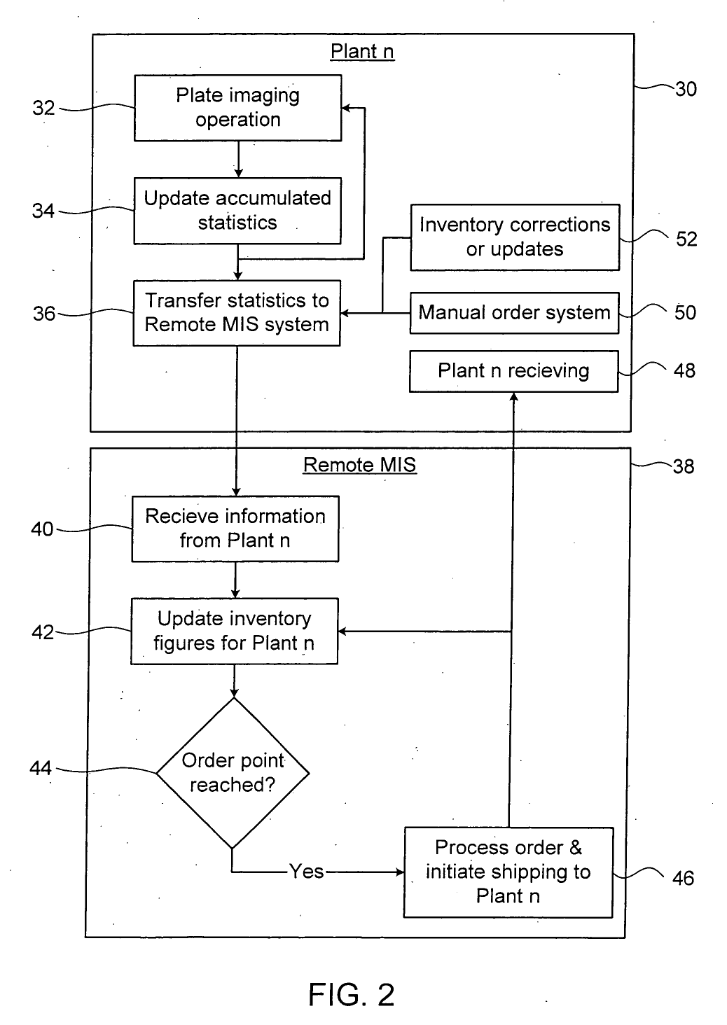

A method according to an embodiment of the invention is depicted as a process flowchart in FIG. 2. A printing plant “n” is shown as outline 30. Events within outline 30 generally occur at the location of plant n. An imaging system in the plant images a plate at step 32 whereafter consumption statistics are up-dated in step 34. The imaging system may continue to image plates and update statistics until a communication is initiated in step 36 and the statistics are transferred as consumption information to a remote MIS shown as outline block 38.

The remote MIS receives the consumption information from plant n in step 40. The statistics, identified as belonging to plant n, are used to update inventory levels in a database for plant n in step 42. The updated inventory levels for plant n are then compared against one or more established order points for plant n in step 44 and if an order point is reached, an order is triggered.

Orders may be automatically generated by the MIS and then shipped to the customer or the MIS may generate a message or other signal to cause the plant to be contacted by the media vendor by phone, e-mail or fax to solicit an order. Regardless of how the actual order is placed or confirmed, the shipment to plant n is initiated in step 46 and the shipment details are used to update inventory figures for plant n in step 42.

The quantity of items to be shipped may be determined in accordance with a pre-determined inventory target that is stored in a database of the remote MIS or entered by the customer at the plant. Alternatively the quantity of items to be shipped may be determined from a more complex calculation incorporating both the actual inventory levels at the plant and a history of recent usage to predict present needs. The advantage of this more complex order calculation is that where consumption is abnormally high or low the order may be adjusted to reflect such conditions. The shipped consumables are received by plant n and placed in on-site inventory in step 48. Plant n does not have to implement a separate inventory planning and monitoring system since this is completely handled by the remote MIS. The remote MIS may automatically generate and provide to the plant a summary of the usage of various types of consumable items. The embodiment shown in FIG. 2 is provided as an example only. In practice there are many different ways to implement such a system.

In another embodiment the order points are maintained in memory or a database at each plant allowing local control over the order points or alternatively, the system may provide remote access to the order points stored in the remote MIS via any suitable interface such as a secure password authenticated web site. Additionally, facilities may be provided to initiate separate manual orders in step 50, or inventory updates and corrections in step 52. These features allow the plant additional flexibility to order consumables when wishing to override the automated ordering process. The inventory update feature allows inventory adjustments to be initiated by plant n, as may be necessary when a customer inventory count is made, or when consumables are found to be defective, expired or incorrectly shipped. This information may be transferred directly to the remote MIS in step 36.

The systems and methods described above beneficially allow printing plants access to an automated ordering system without the expense of installing such a system at their plants. The system may be provided at substantially reduced cost since many imaging systems already generate and accumulate the statistics suitable for use as consumption information and additionally many such systems have remote diagnostic capabilities for maintenance and troubleshooting. Advantageously, the remote MIS may serve a plurality of different printing plants by providing a unique identifier to each plant in order to correctly track usage of consumables by each plant.

As will be apparent to those skilled in the art, in the light of the foregoing disclosure, many alterations and modifications are possible in the practice of this invention without departing from the spirit or scope thereof.

What is claimed is:

1. A method for remotely monitoring consumable usage in a printing plant, the method comprising:
establishing an order point for at least one type of consumable item used in a computer-to-plate imaging line at the printing plant;
determining an initial inventory level for the type of consumable item;
establishing a communication link from the printing plant to a management information system remote from the printing plant and transferring consumption information relevant to the type of consumable item thereto;
updating the inventory level based on the consumption information; and
at the management information system, automatically initiating an order fulfilment process for the type of consumable item when the updated inventory level falls below the order point.

2. A method according to claim 1 wherein updating the inventory level is performed at the management information system.

3. A method according to claim 2 wherein the order point is maintained at the management information system.

4. A method according to claim 1 wherein updating the inventory level is performed at the printing plant and the consumption information comprises the updated inventory level.

5. A method according to claim 1 comprising obtaining consumption information by counting a number of consumable items of the type of consumable items passing a point in the imaging line using a counting mechanism separate from the imaging line.

6. A method according to claim 5 wherein the consumable items comprise items each bearing a machine-readable tag, the counting mechanism comprises a tag reader and counting the number of consumable items comprises reading the tags as the consumable items pass the tag reader.

7. A method according to claim 5 wherein the consumable items comprise printing plates.

8. A method according to claim 7 wherein the consumable items comprise items each bearing a machine-readable tag, the counting mechanism comprises a tag reader and counting the number of consumable items comprises reading the tags as the consumable items pass the tag reader.

9. A method according to claim 1, wherein updating the inventory level comprises monitoring usage of the type of consumable item and updating the inventory level accordingly.

10. A method according to claim 1, wherein updating the inventory level comprises estimating usage of the type of consumable item and updating the inventory level accordingly.

11. A method according to claim 10, wherein estimating usage of the consumable item comprises determining an actual usage for a related consumable item related to the type of consumable item and determining a usage estimate based on the actual usage of the related consumable item.

12. A method according to claim 10, wherein estimating usage of the type of consumable item comprises determining a consumption rate and determining a usage estimate based at least in part on the consumption rate.

13. A method according to claim 1, comprising reporting a summary of the usage of the type of consumable item to the printing plant.

14. A method according to claim 1, wherein initiating an order fulfilment process comprises determining a shipping quantity of the type of consumable item in accordance with an inventory target.

15. A method according to claim 1, wherein establishing an order point comprises determining the order point based on the updated inventory level and a historical consumption rate.

16. A method according to claim 1, wherein establishing an order point comprises:
entering the order point into a controller at the computer to plate imaging line; and
transferring the order point to the remote management information system via the communication link.

17. A method according to claim 1, wherein determining an initial inventory level comprises:
entering the initial inventory level into a controller at the computer to plate imaging line; and
transferring the initial inventory level to the remote management information system via the communication link.

18. A method according to claim 1, comprising:
determining an inventory level adjustment at the printing plant;
entering the inventory level adjustment into a controller at the computer-to-plate imaging line; and
transferring the inventory level adjustment to the remote management information system via the communication link.

19. A method according to claim 1, wherein initiating the order fulfilment process comprises automatically initiating an order and shipping the order to the printing plant without further intervention or confirmation by the printing plant.

20. A system for monitoring usage of a consumable item, the system comprising:
a computer-to-plate imaging line capable of tracking the usage of at least one consumable item;
a remote management information system; and
a transmission channel operably connected between the imaging line and the remote management information system, the transmission channel for transferring consumption information concerning the usage of the consumable item.

21. A system according to claim 20, wherein the transmission channel comprises at least one of:
a modem link via a telephone line;
a internet connection;
a connection over a local area network;
a connection via electronic mail; and
a wireless network connection.

22. A system according to claim 20, wherein the transmission channel transfers information according to a transmission protocol.

23. A system according to claim 22, wherein the transmission protocol comprises CIP4 Job Definition Format.

24. A system according to claim 22, wherein the transmission protocol comprises CIP4 Job Messaging Format.

25. A system according to claim 22, wherein the management information system serves a plurality of printing plants and the transmission protocol comprises an identifier which uniquely identifies one of the plurality of printing plants from which the consumption information originated.
